(19) United States
(12) Patent Application Publication
(10) Pub. No.: US 2025/0062959 A1
(43) Pub. Date: Feb. 20, 2025

(54) DATA TRANSMISSION METHOD AND APPARATUS, COMPUTER-READABLE MEDIUM, AND ELECTRONIC DEVICE

(71) Applicant: TENCENT TECHNOLOGY (SHENZHEN) COMPANY LIMITED, Shenzhen (CN)

(72) Inventor: Yixue LEI, Shenzhen (CN)

(73) Assignee: TENCENT TECHNOLOGY (SHENZHEN) COMPANY LIMITED, Shenzhen (CN)

(21) Appl. No.: 18/935,880

(22) Filed: Nov. 4, 2024

Related U.S. Application Data
(63) Continuation of application No. PCT/CN2023/106509, filed on Jul. 10, 2023.

(30) Foreign Application Priority Data
Sep. 30, 2022 (CN) 202211206091.5

(51) Int. Cl. H04L 41/0823; H04L 43/087

(52) U.S. Cl. CPC H04L 41/0823; H04L 43/087

(57) ABSTRACT

A data transmission method, performed by an access network element, includes: obtaining a first latency variation distribution characteristic of a service data packet indicating a transmission latency range of the service data packet; receiving one or more latency variation conditions of the service data packet determined by a core network element; and configuring a scheduling and transmission policy of the access network element based on the first latency variation distribution characteristic and the one or more latency variation conditions.

### CROSS-REFERENCE TO RELATED APPLICATIONS

This application is a continuation application of International Application No. PCT/CN2023/106509 filed on Jul. 10, 2023, which claims priority to Chinese Patent Application No. 202211206091.5 filed with the China National Intellectual Property Administration on Sep. 30, 2022, the disclosures of each being incorporated by reference herein in their entireties.

### FIELD

This application relates to the field of computers and communication technologies, and in particular, to a data transmission method and apparatus, a computer-readable medium, and an electronic device.

### BACKGROUND

In a 5th-generation (5G) system (5GS) and an evolved 5GS, high bandwidth interactive services such as cloud gaming, virtual reality (VR), augmented reality (AR), mixed reality (MR), extended reality (XR), and cinematic reality (CR) are of significance.

Transmission of data packets of the interactive services may be based on periodicities, and by virtue of which time-frequency resource efficiency of wireless networks, may be improved through a semi-persistent scheduling (SPS) mechanism or a connected-discontinuous reception (C-DRX) mechanism.

### SUMMARY

According to some embodiments, a data transmission method includes: obtaining a first latency variation distribution characteristic of a service data packet indicating a transmission latency range of the service data packet; receiving one or more latency variation conditions of the service data packet determined by a core network element; and configuring a scheduling and transmission policy of the access network element based on the first latency variation distribution characteristic and the one or more latency variation conditions

According to some embodiments, a data transmission apparatus includes: at least one memory configured to store computer program code; at least one processor configured to read the program code and operate as instructed by the program code, the program code comprising: obtaining code configured to cause at least one of the at least one processor to obtain a first latency variation distribution characteristic of a service data packet indicating a transmission latency range of the service data packet; first receiving code configured to cause at least one of the at least one processor to receive one or more latency variation conditions of the service data packet determined by a core network element; and configuration code configured to cause at least one of the at least one processor to configure a scheduling and transmission policy of an access network element based on the first latency variation distribution characteristic and the one or more latency variation conditions.

According to some embodiments, a non-transitory computer-readable storage medium, storing computer code which, when executed by at least one processor, causes the at least one processor to at least: obtain a first latency variation distribution characteristic of a service data packet indicating a transmission latency range of the service data packet; receive one or more latency variation conditions of the service data packet determined by a core network element; and configure a scheduling and transmission policy of an access network element based on the first latency variation distribution characteristic and the one or more latency variation conditions.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture according to some embodiments.

FIG. 2 is a schematic diagram of a transmission process of a multimedia data packet according to some embodiments.

FIG. 3 is a schematic diagram of a system architecture of a data transmission method according to some embodiments.

FIG. 4 is a schematic diagram of a comparison between latency variation distributions during transmission of a service data packet according to some embodiments.

FIG. 5 is a schematic diagram of a system architecture of a data transmission method according to some embodiments.

FIG. 6 is a flowchart of a data transmission method according to some embodiments.

FIG. 7 is a flowchart of a data transmission method according to some embodiments.

FIG. 8 is a flowchart of a data transmission method according to some embodiments.

FIG. 9 is a flowchart of a data transmission method according to some embodiments.

FIG. 10 is an interaction flowchart of a data transmission method according to some embodiments.

FIG. 11 is a flowchart of a data transmission method according to some embodiments.

FIG. 12 is an interaction flowchart of a data transmission method according to some embodiments.

FIG. 13 is a block diagram of a data transmission apparatus according to some embodiments.

FIG. 14 is a block diagram of a data transmission apparatus according to some embodiments.

FIG. 15 is a block diagram of a data transmission apparatus according to some embodiments.

FIG. 16 is a schematic structural diagram of a computer system of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Block diagrams shown in the drawings are functional entities, and do not necessarily correspond to physically independent entities. The functional entities may be implemented in a form of software, or in one or more hardware modules or integrated circuits, in different networks and/or processor apparatuses and/or microcontroller apparatuses, or in a combination thereof.

Flowcharts shown in the drawings are exemplary descriptions and do not necessarily need to be performed in a described order. Some operations may be further divided, and some operations may be combined or partially combined. An actual execution order may be changed according to an actual case.

“A plurality of” in the description means two or more. “And/or” describes an association relationship between associated objects, and indicates that three relationships may exist. For example, A and/or B may represent that only A exists, both A and B exist, and only B exists. The character “/” may indicate an “or” relationship between the associated objects.

As the 5th Generation (5G) mobile communication technology develops, many multimedia services that require a large data amount and a short latency are widely used. For example, interactive service such as cloud gaming services, virtual reality (VR), augmented reality (AR), mixed reality (MR), extended reality (XR), and cinematic reality (CR) are widely used.

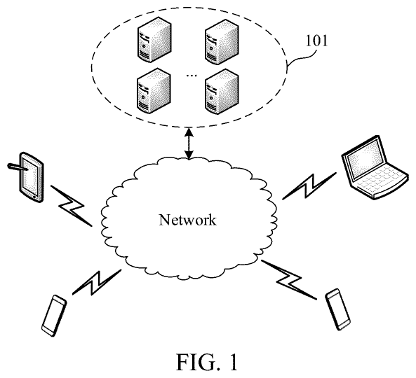

For example, in a cloud gaming scenario shown in FIG. 1, a cloud server 101 is configured to run a cloud game. The cloud server 101 may render a game picture, encode an audio signal and a rendered image, and transmit encoded data to game clients through a network. The game client may be a user equipment (UE) with a streaming media playback capability, a human-computer interaction capability, a communication capability, and the like, such as a smartphone, a tablet computer, a notebook computer, a desktop computer, a smart television, smart home, an on-board terminal, or an aircraft. The game client may be an application running in a terminal device. For example, the game client may decode the encoded data transmitted by the cloud server 101 to obtain an analog audio/video signal and may play the analog audio/video signal.

FIG. 1 shows an exemplary system architecture representing a cloud gaming system, and does not limit an architecture of the cloud gaming system. For example, in some embodiments, the cloud gaming system may further include a backend server configured for scheduling and the like. In addition, the cloud server 101 may be an independent physical server, or may be a server cluster formed by a plurality of physical servers or a distributed system, or may be a cloud server providing cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence (AI) platform. The game client and the cloud server 101 may be directly or indirectly connected through wired or wireless communication, but the disclosure is not limited thereto.

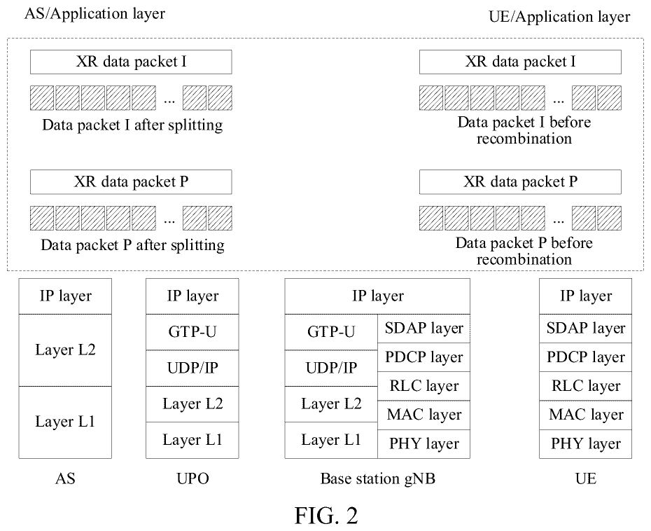

In the multimedia-based interaction service application scenarios, a multimedia data packet may be split into a plurality of data packets for transmission due to a large size. As shown in FIG. 2, in a 5G system (5GS), a user plane may include an application server (AS), a user plane object (UPO) (sometimes referred to as a “user plane function” (UPF) by the 3rd Generation Partnership Project (3GPP), for example), a base station (a next generation nodeB, gNB for short), and a UE. Multimedia data packets may be transmitted in a downlink direction in some service scenarios. For example, the multimedia data packets may be transmitted from the AS to the UPO and to the UE through the gNB. During transmission, a multimedia data packet (an XR data packet is used as an example in FIG. 2) is split at an application layer of the AS, and based on split packets arriving at the UPO from the AS as Internet protocol (IP) packets, the 5GS transmits data sub-packets to a UE side through a protocol data unit (PDU) session, and the data sub-packets are gradually transmitted from a protocol stack to upper layers at the UE side and recombined to recover the multimedia data packet.

In a system shown in FIG. 2, a layer L1 may be a physical layer configured for original data to be transmitted on various physical media. A layer L2 may be a data link layer, which is configured to provide services to a network layer based on services provided by the physical layer. An IP layer may be a network layer, which is configured to achieve data transmission between two end systems. UDP is a user datagram protocol in Chinese. GTP-U is a general packet radio service (GPRS) tunneling protocol user plane in Chinese. PHY is an abbreviation of physical, which refers to a physical layer in Chinese. MAC is media access control in Chinese. RLC is radio link control in Chinese. PDCP is a packet data convergence protocol in Chinese. SDAP is a service data adaptation protocol in Chinese.

For a multimedia service, such as an XR and media (XRM) service, a frame of multimedia data packet may be split into a plurality of data packets for transmission. A data packet formed by a single multimedia service frame or a group of packets (GoP) may have a relatively large number of bytes, which may be carried by a series of IP data packets. A correlation may exist between the IP data packets. Processing the packets based on the correlation may save wireless network bandwidth. Some XRM service flows have a periodicity, and may be, for example, 60 frames per second (FPS), 90 FPS, or 120 FPS data packets, and the video frames generate data packets at a time interval of approximately 16.67 ms, 11.11 ms, or 8.33 ms. Through the periodic characteristic, time-frequency resource efficiency of a wireless network can be improved. For example, a semi-persistent scheduling (SPS) mechanism or a connected-discontinuous reception (C-DRX) mechanism may be adopted based on the periodicity of an XRM service, provided that the 5GS has learned that the XRM service flow has the periodicity.

In some embodiments, an application object (AO) (sometimes referred to as an “application function” (AF) by the 3GPP, for example)/AS may directly provide periodicity information and a latency variation distribution characteristic of a service flow to the 5GS. Based on a resolution of an XR service being increased, a video frame may be split into a plurality of IP data packets for transmission, and periodicities and latency variation distribution characteristics of the split IP data packets may be affected based on the IP data packets being transmitted between a third-party AS and a 5GS gateway. Based on the data packets arriving at a base station for scheduling and transmission over a wireless network, the periodicities and the latency variation distribution characteristics may be changed and may result in a deviation in C-DRX configuration on the base station side.

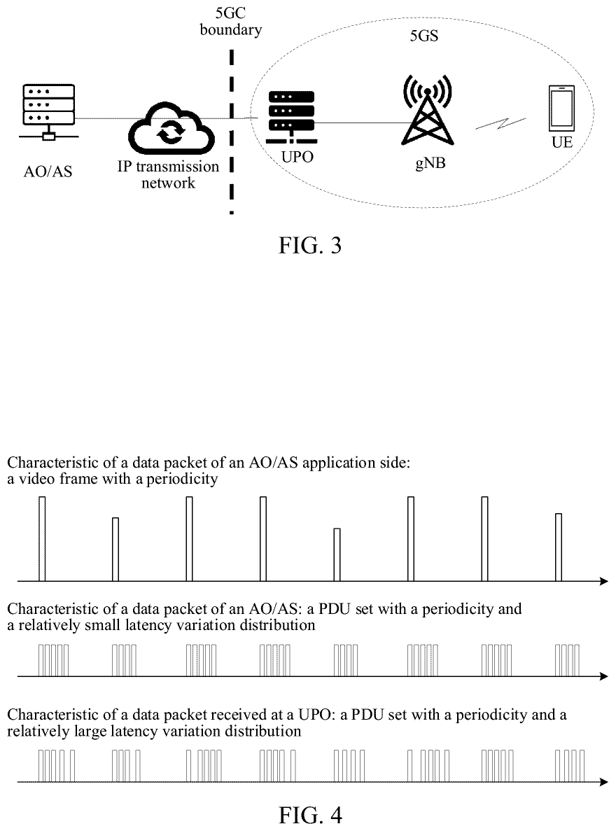

As shown in FIG. 3, the AO/AS may implement a control plane function of a third-party AS, and perform interaction in a manner of AO-network exposure object (NEO) (sometimes referred to as a “network exposure function” (NEF) by the 3GPP, for example)-policy control object (PCO) (sometimes referred to as a “policy control function” (PCF) by the 3GPP, for example) or AO-PCO. The AO/AS entity may implement a user plane function of the third-party AS, for example, in a manner of AS-IP transmission network-UPO interface. FIG. 3 shows a boundary of the 5GS, for example, a deployment location of the 5GS gateway. The 5GS gateway may be a UPO entity, a control plane entity responsible for capability opening such as an NEO or a PCO, or a router/switch node or the like deployed between the 5GS and an external network.

In some embodiments, the IP transmission network may be implemented in a wired or wireless manner. For example, the IP transmission network may be a metropolitan area network, an access network, or a wide area network based on an optical network, which may depend on a topology relationship between a 5G core (5GC) boundary and the third-party AS. Because a 5G network may adopt a network architecture that facilitates sinking of the UPO, if the AO/AS is located at an edge, the UPO may sink to the edge, which may reduce a topological distance between the 5GC boundary (for example, the UPO at the edge position) and the AO/AS. The AO/AS may be located in a central cloud. In this case, sinking of the UPO may not resolve the problem. Impact of the IP transmission network between the third-party AS and the 5GC boundary, for example, the UPO, on service flow transmission may be considered.

As shown in FIG. 4, a characteristic of a data packet of an AO/AS application side, for example, may be a video frame with a periodicity. During transmission, the data packet is split into a plurality of IP data packets. The plurality of IP data packets may form a PDU set. A latency variation distribution of the IP data packets may be relatively small. Because the IP data packets are to be transmitted between the third-party AS and the 5GS gateway, the latency variation distribution of the IP data packets may increases based on the IP data packets arriving at the UPO. As shown in FIG. 4, an increase in a latency between IP data packets in a PDU set may result in an increase in a time for receiving the PDU set.

In some embodiments, the AO/AS may combine periodicity information and a latency variation distribution characteristic of a service data packet with a characteristic of the IP transmission network between the AO/AS and the UPO, to achieve adjustment of the periodicity information and the latency variation distribution characteristic of the service data packet (or adjustment of the latency variation distribution characteristic of the service data packet), and to provide indication information that may be configured for indicating adjusted periodicity information and an adjusted latency variation distribution characteristic of the service data packet to the 5GS, so that a 5GS network element such as the UPO can process an XR data packet based on the adjusted periodicity information and the adjusted latency variation distribution characteristic, including but not limited to C-DRX configuration and SPS scheduling for a radio access network (RAN). The latency variation distribution characteristic is a distribution range of data packets obtained through calculation.

In some embodiments, C-DRX is a discontinuous reception mode in a connected state, a UE may periodically enter a sleep state without detecting a physical downlink control channel (PDCCH), and the UE may be woken up from the sleep state based on detection being requested, thereby achieving power saving.

In addition, the UPO can actively detect the characteristic of the IP transmission network between the AO/AS and the UPO, analyze impact of the characteristic of the transmission network on the periodicity information and the latency variation distribution characteristic. Based on receiving the periodicity information and the latency variation distribution characteristic provided by the AO/AS, the UPO may achieve adjustment of the periodicity information and the latency variation distribution characteristic of the service data packet (or adjustment of the latency variation distribution characteristic of the service data packet) in combination with the characteristic of the IP transmission network between the AO/AS and the UPO, and process the XR data packet based on the adjusted periodicity information and the adjusted latency variation distribution characteristic.

In some embodiments, during the adjustment of the periodicity information and the latency variation distribution characteristic of the service data packet, a rule of the impact of the characteristic of the IP transmission network between the AO/AS and the UPO on the periodicity and the latency variation distribution characteristic of the service data packet may be determined by using an AI method, thereby achieving the adjustment of the periodicity information and the latency variation distribution characteristic of the service data packet.

For example, during the adjustment of the periodicity information and the latency variation distribution characteristic of the service data packet, a range corresponding to an initial latency variation distribution characteristic of [−4 ms, 4 ms] may be modified to [−5 ms, +5 ms] by the 5GC network element such as the PCO. An algorithm may be determined by collecting statistics on forwarding information of a data packet, such as arrival and leaving, but the disclosure is not limited thereto.

Regardless of whether the AO/AS directly provides the periodicity information and the latency variation distribution characteristic of the service flow to the 5GS, or transmits the periodicity information and the latency variation distribution characteristic of the service flow to the 5GS based on adjusting the periodicity information and the latency variation distribution characteristic of the service flow, or an internal network element of the 5GS adjusts the periodicity information and the latency variation distribution characteristic of the service flow, a limitation may exist. Based on the service data packet arriving at the base station for scheduling and transmission over a wireless network, the base station may not ensure that a transmission latency of the service data packet can satisfy latency variation conditions based on performing SPS configuration or C-DRX configuration based on the periodicity and the latency variation distribution characteristic of the service data packet, and service experience may be deteriorated.

In some embodiments, the AO/AS may notify the 5GC of the latency variation conditions (for example, jitter conditions), the 5GC further configures the jitter conditions to the gNB, and the gNB performs C-DRX configuration or C-DRX configuration by using the periodicity of the service data packet and the latency variation distribution characteristic of the service data packet under the jitter conditions, so that the transmission of the data packet satisfies the jitter conditions, C-DRX-based power saving operations or SPS-based time-frequency resource saving can be achieved, and quality of service (QOS) degradation may be avoided, and may facilitate improvement of service experience.

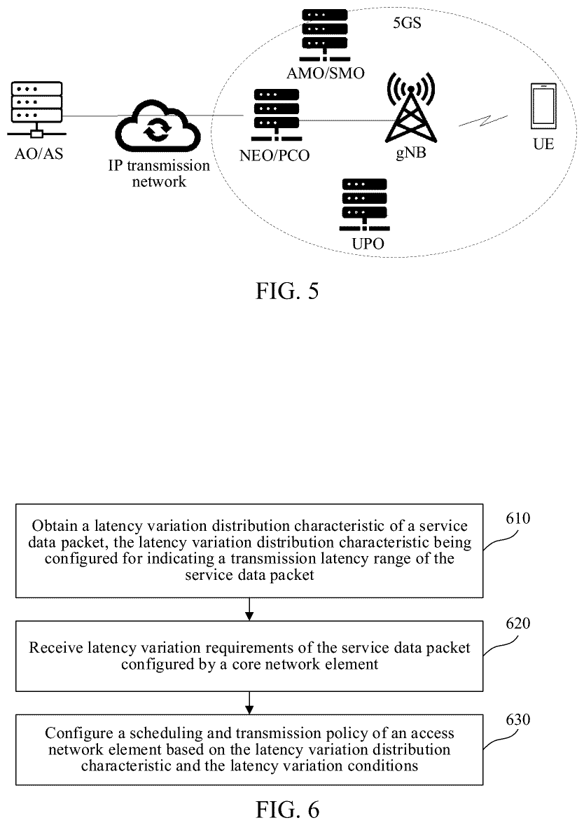

As shown in FIG. 5, similar to the system architecture shown in FIG. 3, the AO/AS can achieve the control plane function of the third-party AS, and can perform interaction in a manner of AO-NEO-PCO or AO-PCO. The AO/AS entity may implement the user plane function of the third-party AS, for example, in the manner of AS-IP transmission network-UPO interface. As a third-party application provider, the AO can provide a QoS condition, including a jitter condition. Moreover, the AO can interact with the NEO or the PCO through a control plane interface, and transmit the jitter condition to the 5GC.

A 5GC network element such as the UPO may collect statistics on traffic characteristics of a data packet, such as a periodicity and a latency variation distribution characteristic (for example, a jitter range), through interaction with the AS or detection, and may provide the information to the base station. The base station may configure a scheduling and transmission policy of an access network element based on the latency variation distribution characteristic and the latency variation conditions, which may achieve configuration of the scheduling and transmission policy of the access network element based on the latency variation distribution characteristic, may satisfy the latency variation conditions, may improve time-frequency resource efficiency, and may avoid QoS degradation.

FIG. 6 is a flowchart of a data transmission method according to some embodiments. The data transmission method may be performed by an access network element, for example, may be performed by a base station (a gNB). Referring to FIG. 6, the data transmission method may include 610 to 630, which are described as follows:

Operation 610: Obtain a latency variation distribution characteristic of a service data packet, the latency variation distribution characteristic being configured for indicating a transmission latency range of the service data packet.

In some embodiments, the service data packet may be a periodic service data packet. Periodicity information of the periodic service data packet may be provided by an AO, for example, may be transmitted by the AO to the access network element through a core network. The periodicity information may be determined based on at least one of the following factors: an encoding/decoding manner of the service data packet, a multimedia service flow transmission parameter corresponding to the service data packet, a push parameter of an AS for a multimedia service flow, and a pull parameter of the AS for the multimedia service flow.

In some embodiments, the encoding/decoding manner of the service data packet may be, for example, one of advanced video coding (AVC), high efficiency video coding (HEVC), versatile video coding (VVC), and the like. The periodicity information of the service data packet may be determined based on the encoding/decoding manner of the service data packet.

In some embodiments, the multimedia service flow transmission parameter corresponding to the service data packet may include service data content included in the service data packet, for example, one or more of audio, a video, haptic information, and the like. The periodicity information of the service data packet may be determined based on the service data content (for example, periodic audio information) included in the service data packet.

In some embodiments, the push parameter of the AS for the multimedia service flow may be a push frame rate (such as a fixed frame rate or a variable frame rate). The pull parameter of the AS for the multimedia service flow may be a pull frame rate (which may be a fixed frame rate or a variable frame rate).

In some embodiments, the obtaining a latency variation distribution characteristic of a service data packet may be receiving a latency variation distribution characteristic transmitted by a core network element. The latency variation distribution characteristic is forwarded by the core network element based on a latency variation distribution characteristic transmitted by an AO entity. The latency variation distribution characteristic may be transmitted by the core network element to the access network element based on adjusting the latency variation distribution characteristic transmitted by the AO entity.

For example, based on determining the latency variation distribution characteristic of the service data packet, the AO may provide the latency variation distribution characteristic to a PCO (the AO may directly transmit the latency variation distribution characteristic to the PCO, or may transmit the latency variation distribution characteristic to an NEO and the NEO may forward the latency variation distribution characteristic to the PCO), and the PCO may configure the latency variation distribution characteristic to the base station through a session management object (SMO) (sometimes referred to as a “session management function” (SMF) by the 3GPP, for example) and/or an access and mobility management object AMO (sometimes referred to as an “access and mobility management function” (AMF) by the 3GPP, for example).

In some embodiments, based on determining the latency variation distribution characteristic of the service data packet, the AO may adjust the latency variation distribution characteristic of the service data packet based on a characteristic of an IP transmission network between the AO/AS and a core network gateway (such as a UPO), and may provide adjusted latency variation distribution characteristic to the PCO. The PCO may configure the adjusted latency variation distribution characteristic to the base station. In some embodiments, impact of a network transmission characteristic between the AS and the core network gateway on the latency variation distribution characteristic of the service data packet may be taken into consideration, so that the adjusted latency variation distribution characteristic can adapt to an actual transmission process of the service data packet, which may avoid a deviation in a configured data transmission control policy as a result of impact of the network transmission characteristic, and may improve accuracy of scheduling the transmission of the service data packet and quality of transmitting the service data packet.

In some embodiments, the UPO may actively detect the characteristic of the IP transmission network between the AO/AS and the UPO, and analyze impact of the characteristic of the IP transmission network on the latency variation distribution characteristic of the service data packet. Based on receiving the latency variation distribution characteristic provided by the AO/AS, the UPO may achieve adjustment of the latency variation distribution characteristic of the service data packet in combination with the characteristic of the IP transmission network between the AO/AS and the UPO, and may configure the adjusted latency variation distribution characteristic to the base station. Based on adjusting the latency variation distribution characteristic, the UPO may configure the adjusted latency variation distribution characteristic to the base station through the core network element. For example, the UPO may configure the adjusted latency variation distribution characteristic to the base station through the SMO. The PCO may subscribe to a network analytics service from a network data analytics object (NWDAO) (sometimes referred to as a “network data analytics function” (NWDAF) by the 3GPP, for example). The service is configured to collect the latency variation distribution characteristic adjusted by the UPO. The PCO may obtain the adjusted latency variation distribution characteristic from the NWDAO, and may configure the adjusted latency variation distribution characteristic to the base station through the SMO and/or the AMO.

In some embodiments, the latency variation distribution characteristic includes a maximum latency variation value and a minimum latency variation value. For example, the latency variation distribution characteristic may be a latency variation distribution range composed of the maximum latency variation value and the minimum latency variation value, or may be a plurality of discrete latency variation values including the maximum latency variation value and the minimum latency variation value.

In some embodiments, the AO may obtain a network transmission status of the service data packet obtained by the AS through statistics collection based on determining the latency variation distribution characteristic of the service data packet, and may determine the maximum latency variation value and the minimum latency variation value based on the network transmission status of the service data packet. In some embodiments, the network transmission status of the service data packet obtained by the AS through statistics collection may be obtained from a network interface between the AS and a transmission network.

Operation 620: Receive latency variation conditions of the service data packet configured by the core network element.

In some embodiments, the receiving latency variation conditions of the service data packet configured by the core network element may be receiving latency variation conditions from the AO entity forwarded by a PCO entity. The latency variation conditions are generated by the AO entity based on service attribute information corresponding to the service data packet, which can represent variations of a latency during data packet transmission inside the 5GS.

Based on determining the latency variation conditions of the service data packet, the AO may provide the latency variation conditions to the PCO (the AO may directly transmit the latency variation conditions to the PCO, or may transmit the latency variation conditions to the NEO and the NEO may forward the latency variation conditions to the PCO), and the PCO may configure the latency variation conditions to the base station through the SMO and/or the AMO.

In some embodiments, the AO may determine the latency variation conditions of the service data packet based on at least one of the following factors: a tolerance of the service data packet for a latency variation, a size of a playback buffer corresponding to the service data packet, a playable duration of the playback buffer corresponding to the service data packet, a service characteristic corresponding to the service data packet, transmitting end capability information of the service data packet, receiving end capability information of the service data packet, and an encoding/decoding algorithm corresponding to the service data packet.

In some embodiments, a smaller tolerance of the service data packet for the latency variation indicates higher latency variation conditions of the service data packet (for example, a smaller required maximum variation frequency or a smaller required maximum variation amplitude). On the contrary, a larger tolerance of the service data packet for the latency variation indicates lower latency variation conditions of the service data packet. For example, cloud gaming data with a high time relevancy requirement has a relatively small tolerance for the latency variation.

In some embodiments, a larger playback buffer corresponding to the service data packet indicates smaller jitter alleviation difficulty. On the contrary, a smaller playback buffer corresponding to the service data packet indicates larger jitter alleviation difficulty. The size of the playback buffer may be inversely correlated with the latency variation conditions. A larger playback buffer may indicate lower latency variation conditions, and a smaller playback buffer may indicate higher latency variation conditions.

In some embodiments, the size of the playback buffer may be related to a playable duration corresponding to the cached service data packet. A larger playback buffer may indicate a larger playable duration, and a smaller playback buffer indicates a smaller playable duration. The playable duration of the playback buffer may be inversely correlated with the latency variation conditions. A larger playable duration of the playback buffer may indicate lower latency variation conditions, and a smaller playable duration of the playback buffer may indicate higher latency variation conditions.

In some embodiments, the service characteristic corresponding to the service data packet may determine the latency variation conditions of the service data packet. For example, if the service characteristic corresponding to the service data packet is a strongly interactive service or a real-time interactive service, it indicates that the latency variation conditions of the service data packet are relatively high. If the service characteristic corresponding to the service data packet is a service that has no excessively high requirement on time relevancy (for example, a data backup service), it indicates that the latency variation conditions of the service data packet are relatively low.

In some embodiments, the transmitting end capability information and the receiving end capability information of the service data packet may be capabilities of the transmitting end and the receiving end in dealing with the latency variation. For example, if the transmitting end has a capability of performing transmission in parallel, and the receiving end can receive data from a plurality of channels and process the data, the transmitting end may transmit the same service data packet in parallel through a plurality of channels (for example, 3 channels), so that the receiving end may perform de-duplication and fusion on the service data packet received through the plurality of channels. The receiving end and the transmitting end may have relatively strong capabilities of dealing with the latency variation, and the corresponding latency variation conditions may be relatively low. If the receiving end and the transmitting end have relatively poor capabilities of dealing with the latency variation, the corresponding latency variation conditions may be relatively high.

In some embodiments, the encoding/decoding algorithm corresponding to the service data packet can determine whether dropping a/some data packets affects recovery of the data packet. If dropping a/some data packets does not affect recovery of the data packet, no large impact is caused even if a latency variation occurs during transmission of the/these data packets, which indicates that the latency variation conditions are relatively low. On the contrary, if dropping a/some data packets affects recovery of the data packet, the latency variation conditions are relatively high during transmission of the/these data packets.

Operation 630: Configure a scheduling and transmission policy of an access network element based on the latency variation distribution characteristic and the latency variation conditions.

In some embodiments, a process of configuring the scheduling and transmission policy of the access network element based on the latency variation distribution characteristic and the latency variation conditions may include adjusting the latency variation distribution characteristic based on the latency variation conditions to obtain an adjusted latency variation distribution characteristic and configuring the scheduling and transmission policy of the access network element based on the adjusted latency variation distribution characteristic. In some embodiments, the scheduling and transmission policy of the access network element may be, for example, performing C-DRX configuration or SPS scheduling.

According to some embodiments, as shown in FIG. 6, based on configuring the scheduling and transmission policy of the access network element, the base station may further detect whether service data transmitted between the AS and the access network element satisfies the latency variation conditions during transmission, and may reconfigure the scheduling and transmission policy of the access network element based on the latency variation distribution characteristic and the latency variation conditions if the service data transmitted between the AS and the access network element does not satisfy the latency variation conditions during the transmission, and may perform data transmission based on the reconfigured scheduling and transmission policy.

The detecting whether service data transmitted between the AS and the access network element satisfies the latency variation conditions during transmission may be detecting whether service data transmitted between the AS and a UE satisfies the latency variation conditions during transmission.

In some embodiments, the process of reconfiguring the scheduling and transmission policy of the access network element based on the latency variation distribution characteristic and the latency variation conditions may be repeated a plurality of times, until the service data transmitted between the AS and the access network element satisfies the latency variation conditions during the transmission based on the scheduling and transmission policy of the access network element being reconfigured.

According to some embodiments, as shown in FIG. 6, the scheduling and transmission policy of the access network element is configured based on the latency variation distribution characteristic and the latency variation conditions, so that the scheduling and transmission policy of the access network element may be configured based on the latency variation distribution characteristic while the latency variation conditions is satisfied, which may avoid QoS degradation while improving time-frequency resource efficiency, and may facilitate improvement of a service experience.

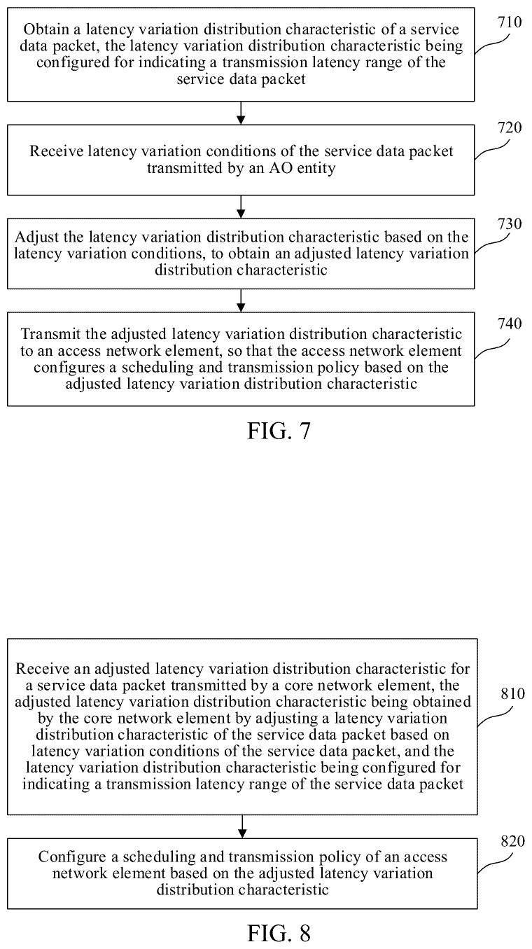

FIG. 7 is a flowchart of a data transmission method according to some embodiments. The data transmission method may be performed by a core network element. The core network element may be a PCO. Referring to FIG. 7, the data transmission method may include 710 to 740, which are described as follows:

Operation 710: Obtain a latency variation distribution characteristic of a service data packet, the latency variation distribution characteristic being configured for indicating a transmission latency range of the service data packet.

In some embodiments, the core network element may obtain the latency variation distribution characteristic of the service data packet from an AO. For example, based on determining the latency variation distribution characteristic of the service data packet, the AO may provide the latency variation distribution characteristic to the PCO (the AO may directly transmit the latency variation distribution characteristic to the PCO, or may transmit the latency variation distribution characteristic to an NEO and the NEO may forward the latency variation distribution characteristic to the PCO).

In some embodiments, based on determining the latency variation distribution characteristic of the service data packet, the AO may adjust the latency variation distribution characteristic of the service data packet based on a characteristic of an IP transmission network between the AO/AS and a core network gateway (such as a UPO), and may provide adjusted latency variation distribution characteristic to the PCO.

In some embodiments, the UPO may actively detect the characteristic of the IP transmission network between the AO/AS and the UPO, and analyze impact of the characteristic of the IP transmission network on the latency variation distribution characteristic of the service data packet. Based on receiving the latency variation distribution characteristic provided by the AO/AS, the UPO may achieve adjustment of the latency variation distribution characteristic of the service data packet in combination with the characteristic of the IP transmission network between the AO/AS and the UPO. The PCO may subscribe to a network analytics service from an NWDAO. The service is configured to collect the latency variation distribution characteristic adjusted by the UPO. The PCO may obtain the adjusted latency variation distribution characteristic from the NWDAO.

In some embodiments, the UPO may detect the characteristic of the IP transmission network between the AO/AS and the UPO, and may analyze impact of the characteristic of the transmission network on the latency variation distribution characteristic of the service data packet. The PCO may subscribe to a network analytics service from the NWDAO. The service is configured to collect a relevant parameter configured for adjusting the latency variation distribution characteristic from the UPO. The PCO may obtain the relevant parameter configured for adjusting the latency variation distribution characteristic from the NWDAO, to achieve the adjustment of the latency variation distribution characteristic of the service data packet.

In some embodiments, the PCO may subscribe to a network analytics service from the NWDAO. The service is configured to collect a relevant parameter configured for adjusting the latency variation distribution characteristic from the UPO and analyze how to adjust the latency variation distribution characteristic of the service data packet based on the characteristic of the network transmission. The PCO may obtain the relevant parameter configured for adjusting the latency variation distribution characteristic from the NWDAO, to achieve the adjustment of the latency variation distribution characteristic of the service data packet.

Operation 720: Receive latency variation conditions of the service data packet transmitted by an AO entity.

In some embodiments, based on determining the latency variation conditions of the service data packet, the AO may provide the latency variation conditions to the PCO (the AO may directly transmit the latency variation conditions to the PCO, or may transmit the latency variation conditions to the NEO and the NEO may forward the latency variation conditions to the PCO).

Operation 730: Adjust the latency variation distribution characteristic based on the latency variation conditions, to obtain an adjusted latency variation distribution characteristic.

Operation 740: Transmit the adjusted latency variation distribution characteristic to an access network element, so that the access network element configures a scheduling and transmission policy based on the adjusted latency variation distribution characteristic.

In some embodiments, a process in which the core network element transmits the adjusted latency variation distribution characteristic to the access network element, for example, may include that the PCO transmits the adjusted latency variation distribution characteristic to the access network element through an SMO and an AMO, and the access network element may configure the scheduling and transmission policy based on the adjusted latency variation distribution characteristic, for example, performs C-DRX configuration or SPS scheduling.

In some embodiments, because the latency variation distribution characteristic is adjusted by the core network element based on the latency variation conditions, based on the adjusted latency variation distribution characteristic being transmitted to the access network element and the access network element configuring the scheduling and transmission policy based on the adjusted latency variation distribution characteristic, a problem that service data transmitted between the AS and the access network element (for example, a UE) does not satisfy the latency variation conditions during transmission may occur. The access network element may trigger the core network element to readjust the latency variation distribution characteristic of the service data packet based on the latency variation conditions.

If receiving triggering information configured for instructing to readjust the latency variation distribution characteristic transmitted by the access network element, the core network element readjusts the latency variation distribution characteristic of the service data packet based on the latency variation conditions of the service data packet, and transmits a readjusted latency variation distribution characteristic to the access network element, so that the access network element reconfigures the scheduling and transmission policy based on the readjusted latency variation distribution characteristic.

In some embodiments, the process of reconfiguring the scheduling and transmission policy of the access network element based on the latency variation distribution characteristic and the latency variation conditions may be repeated a plurality of times, until the service data transmitted between the AS and the access network element satisfies the latency variation conditions during the transmission based on the scheduling and transmission policy of the access network element is reconfigured.

In some embodiments, the core network element may obtain periodicity information of the service data packet and may transmit the periodicity information of the service data packet to the access network element, so that the access network element configures the scheduling and transmission policy based on the periodicity information and the adjusted latency variation distribution characteristic. For example, based on determining the periodicity information of the service data packet, the AO may provide the periodicity information to the PCO (the AO may directly transmit the periodicity information to the PCO, or may transmit the periodicity information to the NEO and the NEO may forward the periodicity information to the PCO), and the PCO may configure the periodicity information to the access network element through the SMO and/or the AMO.

According to some embodiments, as shown in FIG. 7, the core network element may adjust the latency variation distribution characteristic based on the latency variation conditions and may transmit the adjusted latency variation distribution characteristic to the access network element, so that the access network element configures the scheduling and transmission policy, which may achieve configuration of the scheduling and transmission policy of the access network element based on the latency variation distribution characteristic, may satisfy the latency variation conditions, may avoid QoS degradation, and may improve time-frequency resource efficiency.

FIG. 8 is a flowchart of a data transmission method according to some embodiments. The data transmission method may be performed by an access network element, for example, may be performed by a base station (a gNB). Referring to FIG. 8, the data transmission method may include 810 to 820, which are described as follows:

Operation 810: Receive an adjusted latency variation distribution characteristic for a service data packet transmitted by a core network element, the adjusted latency variation distribution characteristic being obtained by the core network element by adjusting a latency variation distribution characteristic of the service data packet based on latency variation conditions of the service data packet, and the latency variation distribution characteristic being configured for indicating a transmission latency range of the service data packet.

Operation 820: Configure a scheduling and transmission policy of an access network element based on the adjusted latency variation distribution characteristic.

In some embodiments, that the access network element configures the scheduling and transmission policy of the access network element may be performing C-DRX configuration, SPS scheduling, or the like.

In some embodiments, based on configuring the scheduling and transmission policy of the access network element, the access network element may further detect whether service data transmitted between an AS and the access network element (for example, a UE) satisfies the latency variation conditions during transmission, and trigger the core network element to readjust the latency variation distribution characteristic of the service data packet based on the latency variation conditions of the service data packet if the service data transmitted between the AS and the access network element does not satisfy the latency variation conditions during the transmission. For example, the access network element transmits triggering information configured for instructing to readjust the latency variation distribution characteristic to the core network element. Based on receiving the triggering information, the core network element may readjust the latency variation distribution characteristic of the service data packet based on the latency variation conditions of the service data packet, and transmit a readjusted latency variation distribution characteristic to the access network element. Based on receiving the readjusted latency variation distribution characteristic transmitted by the core network element, the access network element reconfigures the scheduling and transmission policy of the access network element based on the readjusted latency variation distribution characteristic.

In some embodiments, the process of reconfiguring the scheduling and transmission policy of the access network element based on the latency variation distribution characteristic and the latency variation conditions may be repeated a plurality of times, until the service data transmitted between the AS and the access network element satisfies the latency variation conditions during the transmission based on the scheduling and transmission policy of the access network element being reconfigured.

According to some embodiments, as shown in FIG. 8, the access network element may configure the scheduling and transmission policy based on the latency variation distribution characteristic adjusted by the core network element, which may achieve configuration of the scheduling and transmission policy of the access network element based on the latency variation distribution characteristic, may satisfy the latency variation conditions, may avoid QoS degradation, and may improve time-frequency resource efficiency.

Some embodiments are described above in terms of the access network element and the core network element. Some embodiments are further described in terms of interaction among a plurality of device entities.

Some embodiments involve coordination between jitter conditions and a scheduling and transmission policy of an access network element (for example, a base station (a gNB)), for example, C-DRX configuration and SPS configuration, to prevent the C-DRX configuration from affecting implementation of the jitter conditions.

In some embodiments, a service data packet may be an XR service data packet, or may be another multimedia service data packet, for example, a data packet of a cloud gaming service, or a data packet of a service such as VR, AR, MR, or CR. Some embodiments may be applicable to processing of an XR service data packet or may be applicable to the processing of a data packet of a service such as a cloud gaming service, VR, AR, MR, or CR.

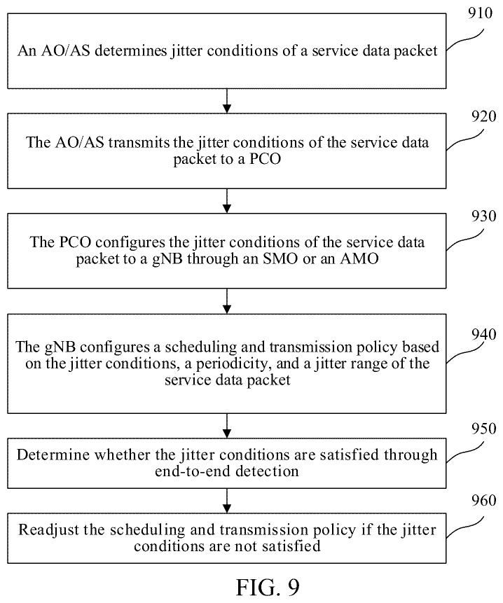

As shown in FIG. 9, a data transmission method according to some embodiments includes the following operations:

Operation 910: An AO/AS determines jitter conditions of a service data packet.

In some embodiments, the AO may determine the latency variation conditions of the service data packet based on at least one of the following factors: a tolerance of the service data packet for a latency variation, a size of a playback buffer corresponding to the service data packet, a playable duration of the playback buffer corresponding to the service data packet, a service characteristic corresponding to the service data packet, transmitting end capability information of the service data packet, receiving end capability information of the service data packet, and an encoding/decoding algorithm corresponding to the service data packet.

Operation 920: The AO/AS transmits the jitter conditions of the service data packet to a PCO.

In some embodiments, based on determining the latency variation conditions of the service data packet, the AO may directly transmit the latency variation conditions to the PCO, or may transmit the latency variation conditions to an NEO and the NEO may forward the latency variation conditions to the PCO.

Operation 930: The PCO configures the jitter conditions of the service data packet to a gNB through an SMO or an AMO.

Operation 940: The gNB configures a scheduling and transmission policy based on the jitter conditions, a periodicity, and a jitter range of the service data packet.

In some embodiments, a process in which the gNB configures the scheduling and transmission policy of an access network element based on the jitter range, the periodicity, and the jitter conditions may include adjusting the latency variation distribution characteristic based on the latency variation conditions to obtain an adjusted latency variation distribution characteristic and configuring the scheduling and transmission policy of the access network element based on the adjusted latency variation distribution characteristic. In some embodiments, the scheduling and transmission policy of the access network element may be, for example, performing C-DRX configuration or SPS scheduling.

Operation 950: Determine whether the jitter conditions are satisfied through end-to-end detection.

In some embodiments, for example, it may be detected whether service data transmitted between the AS and the access network element (for example, a UE) satisfies the latency variation conditions during transmission.

Operation 960: Readjust the scheduling and transmission policy if the jitter conditions are not satisfied.

In some embodiments, a process of readjusting the scheduling and transmission policy may be reconfiguring the scheduling and transmission policy based on the latency variation distribution characteristic and the latency variation conditions, and the reconfiguration process may be repeated a plurality of times, until the service data transmitted between the AS and the access network element satisfies the latency variation conditions during the transmission based on the scheduling and transmission policy of the access network element being reconfigured.

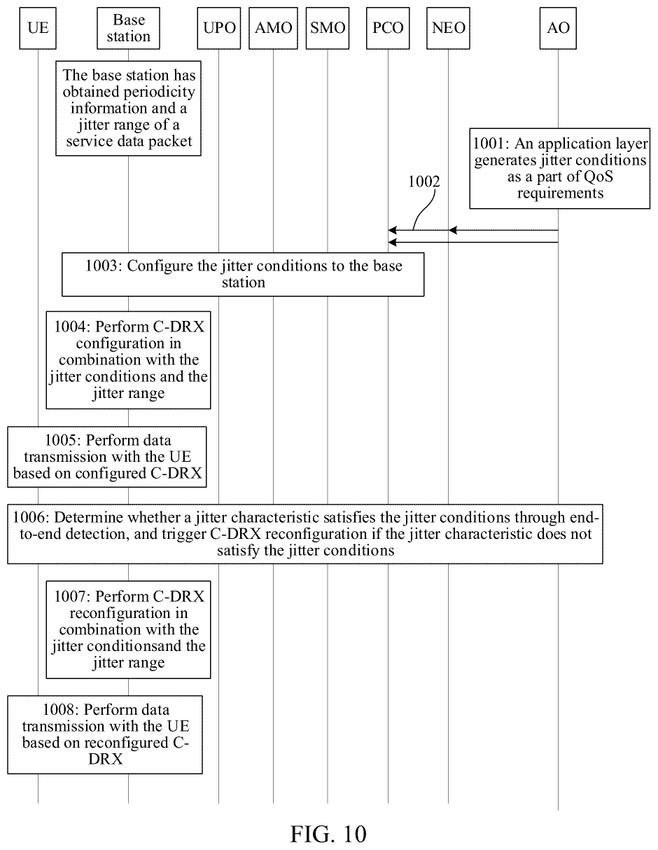

The interaction process of FIG. 9 is shown in FIG. 10 and includes the following operations:

1001: An application layer generates jitter conditions as a part of QoS conditions.

1002: The AO transmits the jitter conditions of a service data packet to the PCO. The AO may directly transmit the jitter conditions to the PCO, or may transmit the jitter conditions to the NEO and the NEO may transmit the jitter conditions to the PCO.

1003: The PCO configures the jitter conditions to the base station. For example, the PCO configures the jitter conditions of the service data packet to the gNB through the SMO or the AMO.

1004: The base station performs C-DRX configuration in combination with the jitter conditions and the jitter range.

In some embodiments, the base station may adjust the latency variation distribution characteristic based on the latency variation conditions to obtain an adjusted latency variation distribution characteristic and may configure the scheduling and transmission policy of the access network element based on the adjusted latency variation distribution characteristic. In some embodiments, the scheduling and transmission policy of the access network element may be, for example, performing C-DRX configuration or SPS scheduling.

1005: The base station performs data transmission with a UE based on configured C-DRX.

1006: Determine whether a jitter characteristic satisfies the jitter conditions through end-to-end detection, and trigger C-DRX reconfiguration if the jitter characteristic does not satisfy the jitter conditions.

In some embodiments, the determining whether a jitter characteristic satisfies the jitter conditions through end-to-end detection may be detecting whether a jitter characteristic between the application layer (for example, the AS) and the UE satisfies the jitter conditions.

1007: Perform C-DRX reconfiguration in combination with the jitter conditions and the jitter range if it is detected that the jitter characteristic does not satisfy the jitter conditions.

1008: The base station performs data transmission with the UE based on reconfigured C-DRX.

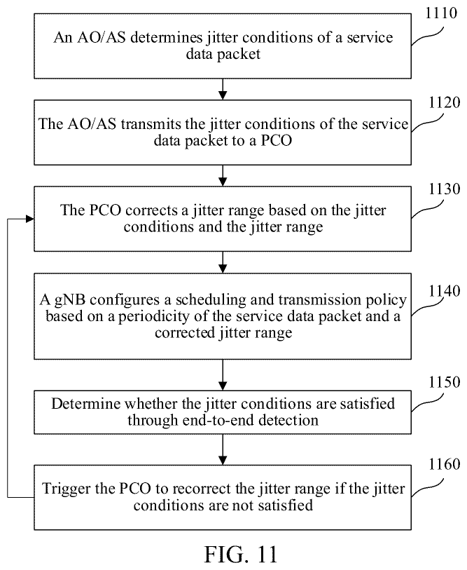

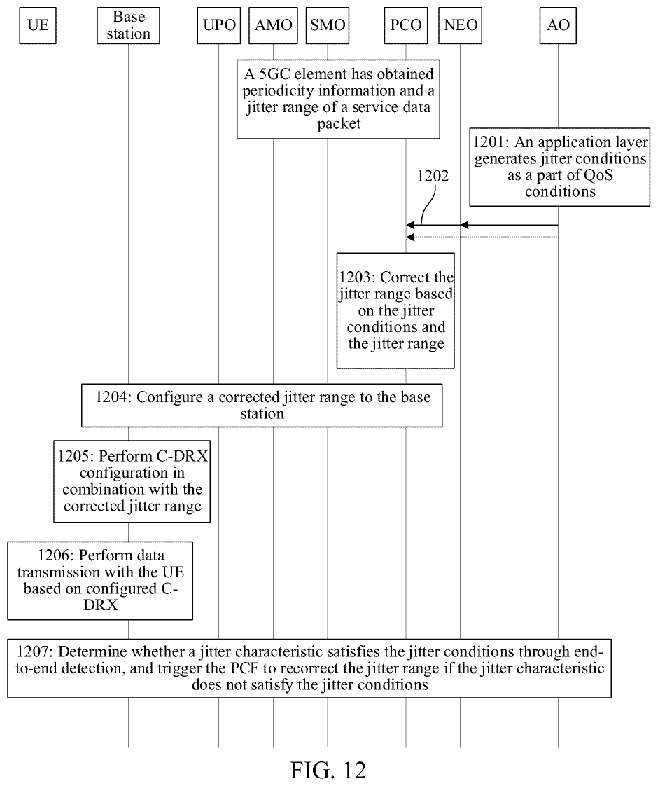

According to some embodiments, FIG. 9 and FIG. 10 illustrate a process in which the access network element, for example, the gNB, configures the scheduling and transmission policy based on the jitter conditions and the jitter range, for which it is assumed that the gNB obtains the periodicity and the jitter range of the service data packet in advance. A process in which a network side configures a scheduling and transmission policy based on jitter conditions and a jitter range is described with reference to FIG. 11 and FIG. 12. In some embodiments, as illustrated in FIG. 11 and FIG. 12, a core network element may obtain a periodicity and the jitter range of a service data packet in advance.

As shown in FIG. 11, a data transmission method according to some embodiments includes the following operations:

Operation 1110: An AO/AS determines jitter conditions of a service data packet.

In some embodiments, the AO may determine the latency variation conditions of the service data packet based on at least one of the following factors: a tolerance of the service data packet for a latency variation, a size of a playback buffer corresponding to the service data packet, a playable duration of the playback buffer corresponding to the service data packet, a service characteristic corresponding to the service data packet, transmitting end capability information of the service data packet, receiving end capability information of the service data packet, and an encoding/decoding algorithm corresponding to the service data packet.

Operation 1120: The AO/AS transmits the jitter conditions of the service data packet to a PCO.

In some embodiments, based on determining the latency variation conditions of the service data packet, the AO may directly transmit the latency variation conditions to the PCO, or may transmit the latency variation conditions to an NEO and the NEO may forward the latency variation conditions to the PCO.

Operation 1130: The PCO corrects a jitter range based on the jitter conditions and the jitter range. Based on correcting the jitter range, the PCO may configure a corrected jitter range to a gNB through an SMO and/or an AMO.

Operation 1140: A gNB configures a scheduling and transmission policy based on a periodicity of the service data packet and the jitter range corrected by the PCO.

In some embodiments, the scheduling and transmission policy of the access network element may be, for example, performing C-DRX configuration or SPS scheduling.

Operation 1150: Determine whether the jitter conditions are satisfied through end-to-end detection.

In some embodiments, for example, it may be detected whether service data transmitted between the AS and the access network element (for example, a UE) satisfies the latency variation conditions during transmission.

Operation 1160: Trigger the PCO to re-correct the jitter range based on the jitter conditions and the jitter range.

In some embodiments, the process of re-correcting the jitter range may be repeated a plurality of times, until the service data transmitted between the AS and the access network element satisfies the latency variation conditions during the transmission based on the scheduling and transmission policy of the access network element being reconfigured.

The interaction process of FIG. 11 is shown in FIG. 12 and includes the following operations:

1201: An application layer generates jitter conditions as a part of QoS conditions.

1202: The AO transmits the jitter conditions of a service data packet to the PCO.

The AO may directly transmit the jitter conditions to the PCO, or may transmit the jitter conditions to the NEO and the NEO may transmit the jitter conditions to the PCO.

1203: The PCO corrects the jitter range based on the jitter conditions and the jitter range.

1204: The PCO configures a corrected jitter range to the base station.

1205: The base station performs C-DRX configuration in combination with the corrected jitter range.

In some embodiments, the scheduling and transmission policy of the access network element may be, for example, performing C-DRX configuration or SPS scheduling.

1206: The base station performs data transmission with a UE based on configured C-DRX.

1207: Determine whether a jitter characteristic satisfies the jitter conditions through end-to-end detection, and trigger the PCO to re-correct the jitter range based on the jitter conditions and the jitter range if the jitter characteristic does not satisfy the jitter conditions.

In some embodiments, the determining whether a jitter characteristic satisfies the jitter conditions through end-to-end detection may be detecting whether a jitter characteristic between the application layer (for example, the AS) and the UE satisfies the jitter conditions.

In some embodiments, the process of re-correcting the jitter range may be repeated a plurality of times, until the service data transmitted between the AS and the access network element satisfies the latency variation conditions during the transmission based on the scheduling and transmission policy of the access network element being reconfigured.

According to some embodiments, during the configuration of the scheduling and transmission policy of the access network element, the latency variation distribution characteristic and the latency variation conditions of the service data packet are taken into consideration, which may achieve configuration of the scheduling and transmission policy of the access network element based on the latency variation distribution characteristic, may satisfy the latency variation conditions, may avoid QoS degradation, may improve time-frequency resource efficiency, or may facilitate improvement of service experience.

According to some embodiments, an apparatus may be configured for performing the data transmission methods.

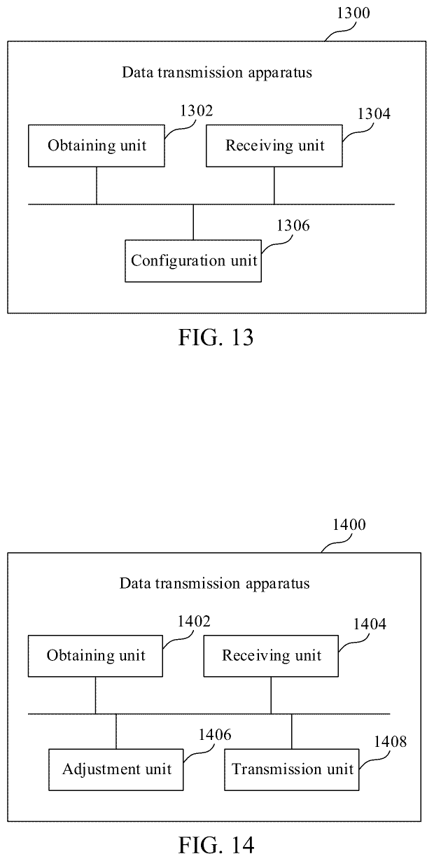

FIG. 13 is a block diagram of a data transmission apparatus according to some embodiments.

Referring to FIG. 13, a data transmission apparatus 1300 according to some embodiments includes an obtaining unit 1302, a receiving unit 1304, and a configuration unit 1306.

The obtaining unit 1302 is configured to obtain a latency variation distribution characteristic of a service data packet, the latency variation distribution characteristic being configured for indicating a transmission latency range of the service data packet. The receiving unit 1304 is configured to receive latency variation conditions of the service data packet configured by a core network element. The configuration unit 1306 is configured to configure a scheduling and transmission policy of an access network element based on the latency variation distribution characteristic and the latency variation conditions.

In some embodiments, the data transmission apparatus 1300 may further include a detection unit, configured to detect whether service data transmitted between an AS and the access network element satisfies the latency variation conditions during transmission based on the scheduling and transmission policy of the access network element being configured.

The configuration unit 1306 is further configured to reconfigure the scheduling and transmission policy of the access network element based on the latency variation distribution characteristic and the latency variation conditions if the service data transmitted between the application server and the access network element does not satisfy the latency variation conditions during the transmission, and perform data transmission based on a reconfigured scheduling and transmission policy.

In some embodiments, the obtaining unit 1302 is configured to receive the latency variation distribution characteristic transmitted by the core network element, the latency variation distribution characteristic being forwarded by the core network element based on a latency variation distribution characteristic transmitted by an AO entity, or the latency variation distribution characteristic being transmitted by the core network element to the access network element based on adjusting the latency variation distribution characteristic transmitted by the AO entity.

In some embodiments, the configuration unit 1306 is configured to: adjust the latency variation distribution characteristic based on the latency variation conditions, to obtain an adjusted latency variation distribution characteristic; and configure the scheduling and transmission policy of the access network element based on the adjusted latency variation distribution characteristic.

In some embodiments, the receiving unit 1304 is configured to receive latency variation conditions from an AO entity forwarded by a PCO entity, the latency variation conditions being generated by the AO entity based on service attribute information corresponding to the service data packet.

In some embodiments, the latency variation conditions are determined based on at least one of the following factors:
a tolerance of the service data packet for a latency variation, a size of a playback buffer corresponding to the service data packet, a playable duration of the playback buffer corresponding to the service data packet, a service characteristic corresponding to the service data packet, transmitting end capability information of the service data packet, receiving end capability information of the service data packet, and an encoding/decoding algorithm corresponding to the service data packet.

FIG. 14 is a block diagram of a data transmission apparatus according to some embodiments.

Referring to FIG. 14, a data transmission apparatus 1400 according to some embodiments includes an obtaining unit 1402, a receiving unit 1404, an adjustment unit 1406, and a transmission unit 1408.

The obtaining unit 1402 is configured to obtain a latency variation distribution characteristic of a service data packet, the latency variation distribution characteristic being configured for indicating a transmission latency range of the service data packet. The receiving unit 1404 is configured to receive latency variation conditions of the service data packet transmitted by an AO entity. The adjustment unit 1406 is configured to adjust the latency variation distribution characteristic based on the latency variation conditions, to obtain an adjusted latency variation distribution characteristic. The transmission unit 1408 is configured to transmit the adjusted latency variation distribution characteristic to an access network element, so that the access network element configures a scheduling and transmission policy based on the adjusted latency variation distribution characteristic.

In some embodiments, the adjustment unit 1406 is further configured to readjust the latency variation distribution characteristic of the service data packet based on the latency variation conditions of the service data packet if triggering information configured for instructing to readjust the latency variation distribution characteristic transmitted by the access network element is received.

The transmission unit 1408 is further configured to transmit a readjusted latency variation distribution characteristic to the access network element, so that the access network element reconfigures the scheduling and transmission policy based on the readjusted latency variation distribution characteristic.

In some embodiments, the obtaining unit 1402 is further configured to obtain periodicity information of the service data packet. The transmission unit 1408 is further configured to transmit the periodicity information of the service data packet to the access network element, so that the access network element configures the scheduling and transmission policy based on the periodicity information and the adjusted latency variation distribution characteristic.

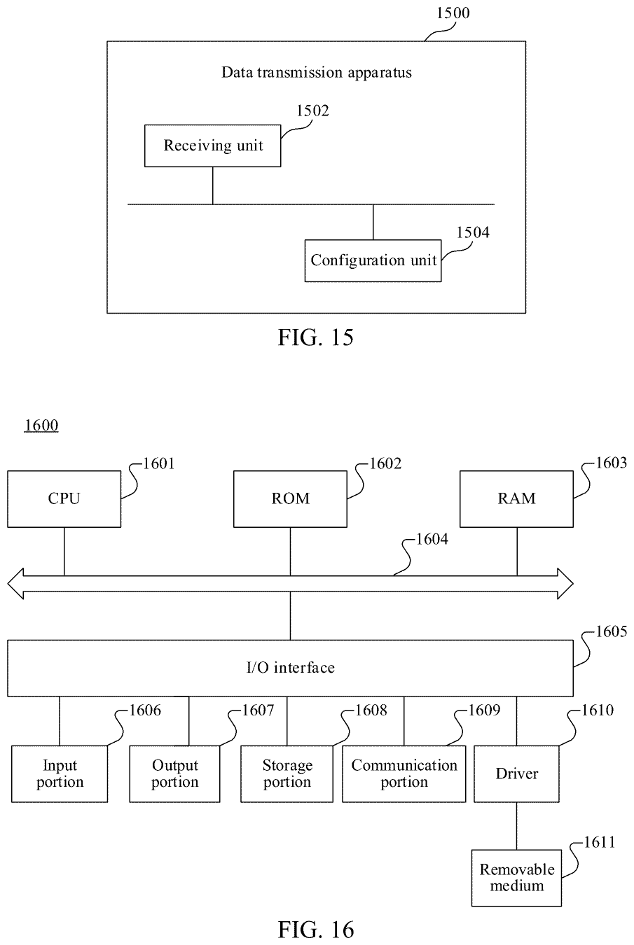

FIG. 15 is a block diagram of a data transmission apparatus according to some embodiments.

Referring to FIG. 15, a data transmission apparatus 1500 according to some embodiments includes a receiving unit 1502 and a configuration unit 1504.

The receiving unit 1502 is configured to receive an adjusted latency variation distribution characteristic for a service data packet transmitted by a core network element, the adjusted latency variation distribution characteristic being obtained by the core network element by adjusting a latency variation distribution characteristic of the service data packet based on latency variation conditions of the service data packet, and the latency variation distribution characteristic being configured for indicating a transmission latency range of the service data packet. The configuration unit 1504 is configured to configure a scheduling and transmission policy of an access network element based on the adjusted latency variation distribution characteristic.

In some embodiments, the data transmission apparatus 1500 further includes a detection unit, configured to detect whether service data transmitted between an AS and the access network element satisfies the latency variation conditions during transmission based on the scheduling and transmission policy of the access network element being configured. a transmission unit, configured to trigger the core network element to readjust the latency variation distribution characteristic of the service data packet based on the latency variation conditions of the service data packet if the service data transmitted between the AS and the access network element does not satisfy the latency variation conditions during the transmission. The receiving unit 1502 is further configured to receive a readjusted latency variation distribution characteristic transmitted by the core network element. The configuration unit 1504 is further configured to reconfigure the scheduling and transmission policy of the access network element based on the readjusted latency variation distribution characteristic.

According to some embodiments, each object, function, or unit may exist respectively or be combined into one or more units. Some objects, functions, or units may be further split into multiple smaller function subunits, thereby implementing the same operations without affecting the technical effects. The objects, functions, or units are divided based on logical functions. A function of one object, function, or unit may be realized by multiple units, or functions of multiple objects, functions, or units may be realized by one unit. In some embodiments, the apparatus may further include other objects, functions, or units. These functions may also be realized cooperatively by the other objects, functions, or units, and may be realized cooperatively by multiple objects, functions, or units.

A person skilled in the art would understand that these “objects,” “functions,” or “units” could be implemented by hardware logic, a processor or processors executing computer software code, or a combination of both. The “objects,” “functions,” or “units” may also be implemented in software stored in a memory of a computer or a non-transitory computer-readable medium, where the instructions of each unit are executable by a processor to thereby cause the processor to perform the respective operations of the corresponding unit.

FIG. 16 is a schematic structural diagram of a computer system of an electronic device according to some embodiments.

A computer system 1600 of the electronic device shown in FIG. 16 is an example, but the disclosure is not limited thereto.

As shown in FIG. 16, the computer system 1600 includes a central processing unit (CPU) 1601. The CPU may perform various actions and processing, for example, perform the method described according to some embodiments, based on a program stored in a read-only memory (ROM) 1602 or a program loaded from a storage portion 1608 into a random access memory (RAM) 1603. The RAM 1603 further has various programs and data required for system operations stored therein. The CPU 1601, the ROM 1602, and the RAM 1603 are connected to each other through a bus 1604. An input/output (I/O) interface 1605 is also connected to the bus 1604.

The following components are connected to the I/O interface 1605: an input portion 1606 including a keyboard, a mouse, and the like, an output portion 1607 including a cathode ray tube (CRT), a liquid crystal display (LCD), a speaker, and the like, a storage portion 1608 including a hard disk and the like, and a communication portion 1609 including a network interface card such as a local area network (LAN) card and a modem. The communication portion 1609 performs communication processing by using a network such as the Internet. A driver 1610 is also connected to the I/O interface 1605 as required. A removable medium 1611, such as a magnetic disk, an optical disc, a magneto-optical disk, or a semiconductor memory is installed on the driver 1610 as required, so that a computer program read from the removable medium is installed into the storage portion 1608 as required.

According to some embodiments, the processes described with reference to the flowcharts may be implemented as computer software programs. For example, some embodiments include a computer program product, including a computer program carried in a computer-readable medium. The computer program includes a computer program configured to perform the methods shown in the flowcharts. The computer program may be downloaded and installed from a network through the communication portion 1609 and/or installed from the removable medium 1611. When the computer program is executed by the CPU 1601, the various functions defined in the system are executed.

The computer-readable medium, according to some embodiments, may be a computer-readable signal medium, a computer-readable storage medium, or any combination thereof. The computer-readable storage medium may be, for example, but is not limited to, an electric, magnetic, optical, electromagnetic, infrared, or semi-conductive system, apparatus, or component, or any combination thereof. Examples of the computer-readable storage medium may include, but are not limited to, an electrical connection having one or more wires, a portable computer magnetic disk, a hard disk, a RAM, a ROM, an erasable programmable read-only memory (EPROM), a flash memory, an optical fiber, a compact disk read-only memory (CD-ROM), an optical storage device, a magnetic storage device, or any proper combination thereof. The computer-readable storage medium may be any tangible medium having a program included or stored therein. The program may be used by or used in combination with an instruction execution system, apparatus, or device. The computer-readable signal medium may include a data signal transmitted in a baseband or as a part of a carrier, which carries a computer-readable computer program. Such a transmitted data signal may have various forms, including but not limited to an electromagnetic signal, an optical signal, or any proper combination thereof. The computer-readable signal medium may be any computer-readable medium other than a computer-readable storage medium. The computer-readable medium may be configured to transmit or propagate a program used by or used in conjunction with an instruction execution system, apparatus, or device. The computer program included in the computer-readable medium may be transmitted by using a medium, including but not limited to a wireless medium, a wired medium, or any proper combination thereof.

The flowcharts and the block diagrams in the drawings illustrate system architectures, functions, and operations that may be implemented by the system, the method, and the computer program product according to some embodiments. Each block in the flowcharts or the block diagrams may represent a module, a program segment, or a part of code. The module, the program segment, or the part of the code includes one or more executable instructions configured for implementing a specified logical function. In some embodiments, functions noted in the blocks may also occur out of the order noted in the drawings. For example, depending on functions involved, two blocks shown in succession may be executed in parallel or may be executed in reverse order. Each block of the block diagrams or the flowcharts and combinations of blocks in the block diagrams or the flowcharts may be implemented by a dedicated hardware-based system configured to perform specified functions or operations, or may be implemented by a combination of dedicated hardware and a computer program.

The involved units described in some embodiments may be implemented by software or hardware, and the described units may be arranged in a processor. Names of the units do not constitute a limitation on the units.

Further provided is a non-transitory computer-readable medium. The computer readable medium may be included in the electronic device in some embodiments or may exist alone without being installed into the electronic device. The computer-readable medium has one or more computer programs carried therein. The one or more computer programs, when executed by the electronic device, may cause the electronic device to implement the methods according to some embodiments.

A person skilled in the art may clearly learn from the above descriptions of the implementations that the exemplary implementations described herein may be implemented by software, or may be implemented by software in combination with hardware. Some embodiments may be implemented in a form of a software product. The software product may be stored in a non-volatile storage medium (which may be a CD-ROM, a USB flash drive, a removable hard disk, or the like) or on the network, including a plurality of instructions configured for causing a computing device (which may be a personal computer, a server, a touch terminal, a network device, or the like) to perform the methods in according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data transmission method, performed by an access network element, the method comprising:
obtaining a first latency variation distribution characteristic of a service data packet indicating a transmission latency range of the service data packet;
receiving one or more latency variation conditions of the service data packet determined by a core network element; and
configuring a scheduling and transmission policy of the access network element based on the first latency variation distribution characteristic and the one or more latency variation conditions.

2. The data transmission method according to claim 1, further comprising:
detecting whether service data transmitted between an application server (AS) and the access network element satisfies the one or more latency variation conditions during a first transmission;
reconfiguring the scheduling and transmission policy based on the service data transmitted between the application server and the access network element not satisfying the one or more latency variation conditions during the first transmission; and
performing a second data transmission based on the reconfigured scheduling and transmission policy.

3. The data transmission method according to claim 1, wherein the obtaining the first latency variation distribution characteristic comprises:
receiving the first latency variation distribution characteristic transmitted by the core network element, and
wherein the first latency variation distribution characteristic is forwarded by the core network element based on a second latency variation distribution characteristic transmitted by an application object (AO) entity, or the first latency variation distribution characteristic is transmitted by the core network element to the access network element based on adjusting the second latency variation distribution characteristic.

4. The data transmission method according to claim 1, wherein the configuring the scheduling and transmission policy comprises:
adjusting the first latency variation distribution characteristic based on the one or more latency variation conditions, to obtain an adjusted latency variation distribution characteristic; and
configuring the scheduling and transmission policy based on the adjusted first latency variation distribution characteristic.

5. The data transmission method according to claim 1, wherein the receiving the one or more latency variation conditions comprises:
receiving the one or more latency variation conditions from an AO entity forwarded by a policy control object (PCO) entity, and
wherein the one or more latency variation conditions are generated by the AO entity based on service attribute information corresponding to the service data packet.

6. The data transmission method according to claim 5, wherein the service attribute information includes at least one of:
a tolerance of the service data packet for a latency variation, a size of a playback buffer corresponding to the service data packet, a playable duration of the playback buffer corresponding to the service data packet, a service characteristic corresponding to the service data packet, transmitting end capability information of the service data packet, receiving end capability information of the service data packet, or an encoding/decoding algorithm corresponding to the service data packet.

7. The data transmission method according to claim 4, wherein the scheduling and transmission policy is configured based on periodicity information of the service data packet and the adjusted latency variation distribution characteristic,
wherein the core network element obtains the periodicity information, and
wherein the core network element transmits the periodicity information to the access network element.

8. The data transmission method according to claim 3, further comprising:
detecting whether service data transmitted between an application server (AS) and the access network element satisfies the one or more latency variation conditions during a first transmission;
triggering the core network element to readjust the first latency variation distribution characteristic based on the one or more latency variation conditions of the service data packet based on the service data transmitted between the AS and the access network element not satisfying the one or more latency variation conditions during the first transmission;
receiving a readjusted latency variation distribution characteristic transmitted by the core network element; and
reconfiguring the scheduling and transmission policy of the access network element based on the readjusted latency variation distribution characteristic.

9. A data transmission apparatus, comprising:
at least one memory configured to store computer program code;
at least one processor configured to read the program code and operate as instructed by the program code, the program code comprising:
obtaining code configured to cause at least one of the at least one processor to obtain a first latency variation distribution characteristic of a service data packet indicating a transmission latency range of the service data packet;
first receiving code configured to cause at least one of the at least one processor to receive one or more latency variation conditions of the service data packet determined by a core network element; and
configuration code configured to cause at least one of the at least one processor to configure a scheduling and transmission policy of an access network element based on the first latency variation distribution characteristic and the one or more latency variation conditions.

10. The data transmission apparatus according to claim 9, further comprising:
first detecting code configured to cause at least one of the at least one processor to detect whether service data transmitted between an application server (AS) and the access network element satisfies the one or more latency variation conditions during a first transmission;
reconfiguring code configured to cause at least one of the at least one processor to reconfigure the scheduling and transmission policy based on the service data transmitted between the application server and the access network element not satisfying the one or more latency variation conditions during the first transmission; and
performing code configured to cause at least one of the at least one processor to perform a second data transmission based on the reconfigured scheduling and transmission policy.

11. The data transmission apparatus according to claim 9, wherein the obtaining code is configured to cause at least one of the at least one processor to receive the first latency variation distribution characteristic transmitted by the core network element, and
wherein the first latency variation distribution characteristic is forwarded by the core network element based on a second latency variation distribution characteristic transmitted by an application object (AO) entity, or the first latency variation distribution characteristic is transmitted by the core network element to the access network element based on adjusting the second latency variation distribution characteristic.

12. The data transmission apparatus according to claim 9, wherein the configuration code is configured to cause at least one of the at least one processor to:
adjust the first latency variation distribution characteristic based on the one or more latency variation conditions, to obtain an adjusted latency variation distribution characteristic; and
configure the scheduling and transmission policy based on the adjusted first latency variation distribution characteristic.

13. The data transmission apparatus according to claim 9, wherein the first receiving code is configured to cause at least one of the at least one processor to receive the one or more latency variation conditions from an AO entity forwarded by a policy control object (PCO) entity, and
wherein the one or more latency variation conditions are generated by the AO entity based on service attribute information corresponding to the service data packet.

14. The data transmission apparatus according to claim 13, wherein the service attribute information includes at least one of:
a tolerance of the service data packet for a latency variation;
a size of a playback buffer corresponding to the service data packet;
a playable duration of the playback buffer corresponding to the service data packet;
a service characteristic corresponding to the service data packet;
transmitting end capability information of the service data packet;
receiving end capability information of the service data packet; or
an encoding/decoding algorithm corresponding to the service data packet.

15. The data transmission apparatus according to claim 12, wherein the scheduling and transmission policy is configured based on periodicity information of the service data packet and the adjusted latency variation distribution characteristic,
wherein the core network element obtains the periodicity information, and
wherein the core network element transmits the periodicity information to the access network element.

16. The data transmission apparatus according to claim 11, further comprising:
second detecting code configured to cause at least one of the at least one processor to detect whether service data transmitted between an application server (AS) and the access network element satisfies the one or more latency variation conditions during a first transmission;
triggering code configured to cause at least one of the at least one processor to trigger the core network element to readjust the first latency variation distribution characteristic based on the one or more latency variation conditions of the service data packet based on the service data transmitted between the AS and the access network element not satisfying the one or more latency variation conditions during the first transmission;
second receiving code configured to cause at least one of the at least one processor to receive a readjusted latency variation distribution characteristic transmitted by the core network element; and
reconfiguring code configured to cause at least one of the at least one processor to reconfigure the scheduling and transmission policy of the access network element based on the readjusted latency variation distribution characteristic.

17. A non-transitory computer-readable medium, storing computer code which, when executed by at least one processor, causes the at least one processor to at least:
obtain a first latency variation distribution characteristic of a service data packet indicating a transmission latency range of the service data packet;
receive one or more latency variation conditions of the service data packet determined by a core network element; and
configure a scheduling and transmission policy of an access network element based on the first latency variation distribution characteristic and the one or more latency variation conditions.

18. The non-transitory computer-readable medium, according to claim 17, further comprising:
detecting whether service data transmitted between an application server (AS) and the access network element satisfies the one or more latency variation conditions during a first transmission;
reconfiguring the scheduling and transmission policy based on the service data transmitted between the application server and the access network element not satisfying the one or more latency variation conditions during the first transmission; and
performing a second data transmission based on the reconfigured scheduling and transmission policy.

19. The non-transitory computer-readable medium, according to claim 17, wherein the obtaining the first latency variation distribution characteristic comprises:
receiving the first latency variation distribution characteristic transmitted by the core network element, and
wherein the first latency variation distribution characteristic is forwarded by the core network element based on a second latency variation distribution characteristic transmitted by an application object (AO) entity, or the first latency variation distribution characteristic is transmitted by the core network element to the access network element based on adjusting the second latency variation distribution characteristic.

20. The non-transitory computer-readable medium, according to claim 17, wherein the configuring the scheduling and transmission policy comprises:
adjusting the first latency variation distribution characteristic based on the one or more latency variation conditions, to obtain an adjusted latency variation distribution characteristic; and
configuring the scheduling and transmission policy based on the adjusted first latency variation distribution characteristic.
